(19) United States
(12) Patent Application Publication
(10) Pub. No.: US 2010/0026757 A1
(43) Pub. Date: Feb. 4, 2010

(54) LIQUID EJECTION HEAD UNIT, LIQUID EJECTION HEAD MODULE, AND LIQUID EJECTION APPARATUS

(75) Inventors: Makoto KAWAMOTO, Matsumoto-shi (JP); Yoshihiro KOBAYASHI, Matsumoto-shi (JP); Masato MITSUHASHI, Hara-mura (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/512,918

(22) Filed: Jul. 30, 2009

(30) Foreign Application Priority Data
Jul. 31, 2008 (JP) 2008-198091

(51) Int. Cl. B41J 2/165

(52) U.S. Cl. 347/33

(57) ABSTRACT

A liquid ejection head unit has a carriage, a liquid ejection head for discharging liquid droplets through a nozzle opening of a nozzle formation surface, and a wiping member. The liquid ejection head and wiping member are moved relative to each other to allow the wiping member to come in contact and slide across the nozzle formation surface of the liquid ejection head so as to wipe the nozzle formation surface. An adhesion prevention plate is provided in the carriage on the downstream side in the wiping direction of the liquid ejection head.

### BACKGROUND OF THE INVENTION

The entire disclosures of Japanese Patent Application No. 2008-198091, filed Jul. 31, 2008 is expressly incorporated herein by reference.

1. Technical Field

The present invention relates to a liquid ejection head module and a liquid ejection apparatus. More particularly, the present invention relates to a liquid ejection head such as an ink jet print head and a liquid ejection apparatus capable of preventing the scattering of liquid droplets during wiping.

2. Related Art

Many liquid ejection heads are currently known in the art which discharge a liquid in the form of liquid droplets from a nozzle opening by generating a change in pressure in the liquid in a pressure generating chamber. For example, an ink jet print head (hereinafter, referred to as a print head) is typically used in an image printing apparatus such as an ink jet print apparatus (hereinafter, referred to as a printer), in a color material ejection head for manufacturing a color filter used in a liquid crystal display or the like, in an electrode material ejection head for forming an electrode used in an organic electroluminescence (EL) display, a field emission display (FED) and the like, a bio-organic material ejection head used for manufacturing a biochip (biochemical element), and the like.

The print head is generally configured by forming a passageway unit in which a series of liquid passageways which extend from a reservoir through the pressure generating chamber to a nozzle, an actuator unit having a pressure generation element used for changing the volume of the pressure generating chamber, and a head case made of resin. In addition, a nozzle plate made of metal, which contains the nozzles, is joined to the passageway unit.

The printer generally contains a number of print or unit heads in a head module, the print heads being disposed in the transport direction of a print medium in a zigzag formation which is perpendicular to the transport direction. Using this configuration, it is not necessary to move the print head in the main scanning direction and in the case of a printer, it is possible to print an image by only transporting the printing medium in a vertical scanning direction. Because the printing medium need only be transported in a single direction, the amount of time needed to perform the printing process is less than when a serial print head is used.

The print head has a wiper blade which acts as a wiping member which has elasticity and slides so as to allow a free end to come in contact with the surface of a nozzle plate in order to wipe away any liquid droplets adhered to the surface of the nozzle plate. During the wiping process, the free end of the wiper blade slides across the surface of the nozzle plate, passing the edge of the nozzle plate. In some cases, the wiper blade bends and then springs back when it reaches the edge of the nozzle plate, causing liquid adhered to the wiper blade to be scattered. In some cases, the flying liquid droplets adhere to a side surface of a print head or the nozzle plate. In order to prevent the spray of liquid, many printers, such as the printer described in Japanese Patent Reference JP-A-2002-283581, have a scattering preventing plate that contains the spray.

However, in some instances when the elastic deformation of the wiping member causes the liquid to scatter, or when the wiping operation is performed rapidly, the ink droplets are scattered at the moment when the wiping member is separated from the nozzle formation surface even if the elastic deformation of the wiping member does not occur. Therefore, in order to prevent the problems, the entire space around the wiper blade has to be covered. In addition, in the case where plural print heads are arranged next to each other, when liquid droplets fly toward an adjacent print head from a space that is not covered by the scattering preventing plate, the flying liquid droplets adhere to a side surface of the print head or the nozzle plate. In some cases this may lead to defects of the print head or printing errors as the flying liquid droplets adhere to the nozzle plate.

### BRIEF SUMMARY OF THE INVENTION

An advantage of some aspects of the invention is that it provides a liquid ejection head unit capable of preventing the scattering of liquid droplets during wiping, a liquid ejection head module, and a liquid ejection apparatus.

A first aspect of the invention is a liquid ejection unit. The unit includes a liquid ejection head for discharging liquid droplets through a nozzle opening on a nozzle formation surface, a carriage that holds the liquid ejection head, the carriage including an adhesion prevention plate, and a wiping member. The liquid ejection head and the wiping member are moved relative to each other to allow the wiping member to come in contact and slide across the nozzle formation surface of the liquid ejection head, thereby wiping the nozzle formation surface in a wiping direction, and wherein the adhesion prevention plate is provided in the carriage on the downstream side of the liquid ejection head in the wiping direction.

Using this configuration, the liquid ejection head and the wiping member are moved relative to each other so that the wiping member comes in contact and slides across the nozzle formation surface of the liquid ejection head to wipe the nozzle formation surface. In addition, the adhesion prevention plate is provided in the carriage on the downstream side of the liquid ejection head in the wiping direction. Therefore, even if the liquid adhered to the wiping member sprays as the wiping member recovers from the bent state, the path of the liquid spray is blocked by the adhesion prevention plate and the liquid droplets land on the adhesion prevention plate. Therefore, it is possible to prevent the liquid droplets from scattering in the area around the liquid ejection head. As a result, it is possible to suppress defects of the liquid ejection head caused by the adhesion of the liquid droplets to the side surface of the liquid ejection head or the generation of printing errors due to the adhesion of the liquid droplets to the nozzle of the nozzle plate.

Another aspect of the invention is a liquid ejection head module including a plurality of liquid ejection heads as described above disposed on a carriage. A connection plate that connects a series of adhesion prevention plates which are provided for each of the liquid ejection heads.

As with the first embodiment of the invention, because there are connection plates provided so as to connect the adhesion prevention plates to one another, the stiffness of the carriage can be enhanced. In addition, the area which covers the heads of the liquid ejection apparatus is widened, making it possible to reliably prevent the liquid droplets scattering from the wiping member and landing on the heads of the liquid ejection apparatus.

### BRIEF DESCRIPTION OF THE DRAWINGS

The invention will be described with reference to the accompanying drawings, wherein like numbers reference like elements.

FIG. 1 is a perspective view for explaining the configuration of a printer;

FIG. 2 is a plan view illustrating the configuration of a line head;

FIG. 3 is a sectional view illustrating the main part of a unit head;

FIGS. 4A to 4D are explanatory views for explaining the method for wiping of a nozzle formation surface of the unit head;

FIG. 5 is a sectional view for explaining a capping mechanism;

FIGS. 6A and 6B are sectional views for explaining the configuration of a line head according to a second embodiment of the invention; and

FIG. 7 is a plan view illustrating the configuration of a line head according to a third embodiment.

### DESCRIPTION OF EXEMPLARY EMBODIMENTS

Hereinafter, exemplary embodiments of the invention will be described with reference to the accompanying drawings. In addition, although the embodiments described later are limited to examples illustrating aspects of the invention, the range of the invention is not limited to these embodiments and the examples are exemplary only and do not limit the scope of the following claims. In addition, embodiments of the invention are described below with reference to an image print apparatus, more particularly called an ink jet printer, which is an example of a type of liquid ejection apparatus which is capable of performing aspects of the invention. More particularly, the invention is described with reference to long liquid ejection head, hereinafter, called a line head The line head ejection head has a group of nozzle openings that are disposed at equal pitches with lengths corresponding to the maximum print width of a print sheet.

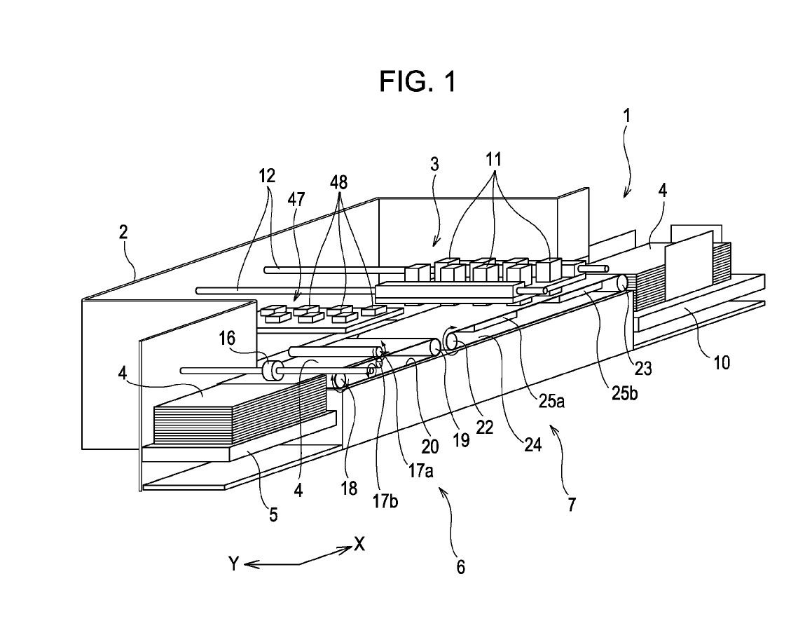

FIG. 1 is a partially cutaway perspective view illustrating the schematic configuration of a printer 1 according to an embodiment of the invention. The printer 1 of this embodiment includes in a housing 2, a line head module 3, which comprises a liquid ejection head module having plurality of unit heads 11 which are arranged in a zigzag formation, a sheet feed tray 5 into which print sheets 4 are loaded in a stacked state, a sheet feeder 6 which pulls the print sheet 4 from the sheet feed tray 5 one by one in order to supply the print sheet 4 to the downstream side of the line head module 3, a transporting unit 7 for transporting the print sheet 4 supplied from the sheet feeder 6, and a sheet output tray 10 which carries the print sheets 4 which are printed on by the line head module 3 and discharged so that text, images, or the like can be printed on the overall width of the print region of the print sheet 4 without scanning the line head module 3. In addition, the printer 1 according to the embodiment of the invention may also use a liquid ejection head module (serial head) having a single unit head 11 instead of a line head having plural unit heads.

An ink cartridge not shown acts as a liquid storage unit that stores ink and is provided in the housing 2. In addition, the ink stored in the cartridge is supplied (pumped) into each of the head units 11 in the line head module 3 through an ink supplying tube by the pressurizing of the ink cartridge using an air pump or the like.

In addition, a print position is set in an upper region of the transporting unit 7 in the housing 2 where an image or the like is printed on the print sheet 4 by ejecting ink from the line head module 3, and a standby position (home position) is set at which the line head module 3 stays away from the print position in the case where the line head module 3 is not performing a printing operation. The line head module 3 is supported so as to be movable by a guide shaft 12 extending through the print position and the standby position and is configured to advance and retreat between the standby position and the print position along the guide shaft 12 by the operation of a head moving mechanism. The standby position will be described later in detail.

The sheet feeder 6 includes a pickup roller 16, a pair of upper and lower feed rollers 17a and 17b, and a feed belt 20, which is an endless belt, wound between a drive roller 18 and a driven roller 19. The pickup roller 16, which is driven to rotate by a motor which is not shown, rotates while being in contact with the uppermost print sheet 4 in the sheet feed tray 5 so as to continuously pull the uppermost print sheet 4 from the sheet feed tray 5. In addition, the feed rollers 17a and 17b nip and feed the uppermost print sheet 4 to the feed belt 20. The drive roller 18 is rotated by a rotation driving source (not shown) to drive the feed belt 20 and send the print sheets 4 placed on the feed belt 20 downstream to the transporting unit 7.

The transporting unit 7 includes a transport belt 24 wound around a transportation drive roller 22 and a transportation driven roller 23 and guide plates 25a and 25b (platen) for supporting the print sheets 4, which are placed on the transport belt 24, from the inner side of the transport belt 24. The transportation drive roller 22 is rotated by a rotation driving source (not shown), operating in synchronization with the printing operation of the line head module 3 to drive the transport belt 24, which is an endless belt. The transport belt 24 passes the print sheets 4 fed from the sheet feeder 6 below the line head module 3 to print an image or the like on the print sheets 4. Then, the print sheets 4 are transported toward the sheet output tray 10.

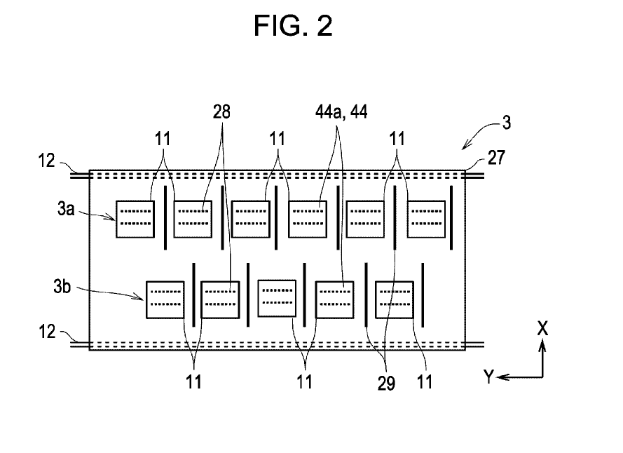

FIG. 2 is a plan view illustrating the configuration of the line head module 3 in this embodiment when viewed from the nozzle formation surface. In the line head module 3, as illustrated in the figure, two rows of the individual print heads 11 are arranged so as to be fixed to a base portion 27 in a direction “Y” which is perpendicular to the transport direction of the print sheets 4, which is herein referred to as direction “X.” The nozzle openings 28 formed at the unit heads 11 are arranged to have lengths corresponding to the maximum print width of the print sheets 4.

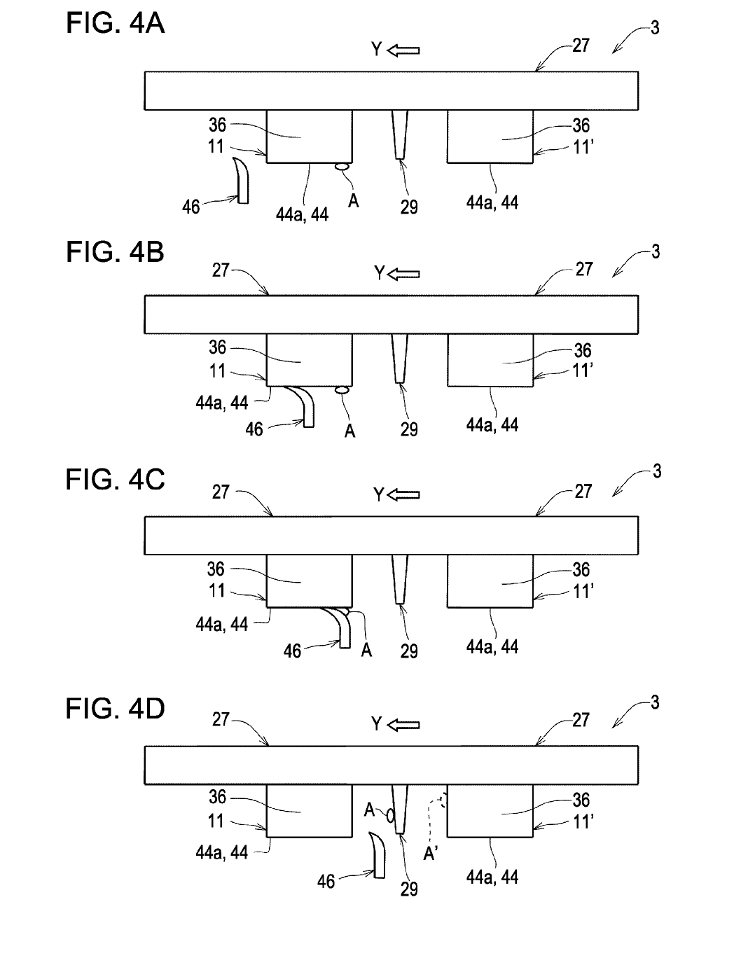

The base portion 27 is provided with an adhesion prevention plate 29 on the downstream side in the Y direction of each of the unit heads 11 (see FIGS. 2 and 4). The rear end of the adhesion prevention plate 29 is attached to the base portion 27, while the front end thereof protrudes downward. A longitudinal direction of the adhesion prevention plate 29 extends in the X direction, and the width thereof in the X direction is greater than the width of the unit heads 11 in the X direction. The base portion 27 is attached to the guide shaft 12 so as to be able to move, and as the base portion 27 is moved along the guide shaft 12 by a head movement mechanism which is not shown, the line head module 3 advances and retreats between the standby position and the print position.

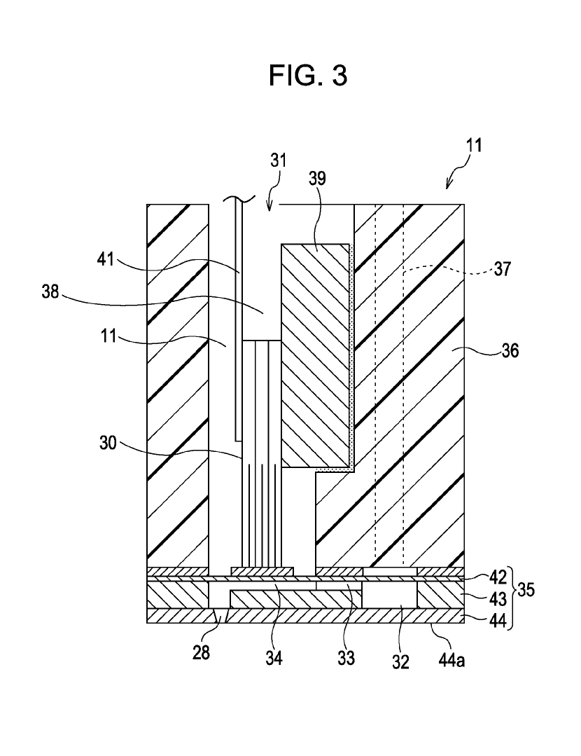

FIG. 3 is a sectional view illustrating the main part of the unit head related to the invention. The individual unit heads 11 include an actuator unit 31 having a plurality of piezoelectric vibrators 30, a passageway unit 35 which forms a series of ink passageways extending from a common ink chamber 32 through ink supply openings 33, and a pressure generating chamber 34 to the nozzle opening 28, a head case 36, and the like.

The head case 36 is a casing having a hollow box shape. The head case 36 includes a case passageway 37 that is a passageway for introducing the ink from the ink cartridge side to the common ink chamber 32, and an accommodation chamber 38 for individually accommodating the actuator unit 31. The head case 36 is formed from an epoxy resin that which comprises a thermosetting resin, and the passageway unit 35 is fixed to the passageway attachment surface.

The actuator unit 31 includes the piezoelectric vibrator 30 as the pressure generation means, a fixed plate 39 made of metal which is joined to the piezoelectric vibrator 30, and a flexible cable 41 used for applying a drive signal from a wiring substrate 40 to the piezoelectric vibrator 30. In each piezoelectric vibrator 30, a free end protrudes outward beyond the front end surface of the fixed plate 39, in a so-called cantilever state, so as to be attached to the fixed plate 39 formed of a metal plate such as stainless steel. In addition to the configuration including the piezoelectric vibrator described above, the pressure generation means may also comprise an electrostatic actuator, a magnetostrictor, a heater element, and the like.

The passageway unit 35 is manufactured by stacking and joining passageway unit configuration members that include a vibration plate 42, a passageway substrate 43, and a nozzle substrate 44 or nozzle plate so as to be integrated into a whole unit. In the passageway unit 35, the pressure generating chamber 34 is formed as a narrow and long space in a direction perpendicular to the row direction of the nozzle opening 28 or nozzle row direction. The common ink chamber 32 is a chamber to which the ink is introduced from the ink cartridge side. In addition, the ink introduced to the common ink chamber 32 is distributed and supplied to each pressure generating chamber 34 through the ink supply openings 33.

The nozzle substrate 44 disposed at a bottom portion of the passageway unit 35 is a thin plate made of metal, which is provided with plurality of nozzle openings disposed in rows at intervals corresponding to the dot formation density. The nozzle plate 44 in this embodiment is manufactured using a stainless steel plate and is provided with plurality of rows of the nozzle openings 28 along the Y direction in order to form nozzle rows. One nozzle row is constituted by, for example, 360 nozzle openings 28.

Next, the configuration of the standby position will be described. FIGS. 4A to 4D are explanatory views for explaining the wiping of a nozzle formation surface 44a in the unit heads 11. A wiper blade 46 is used as a wiping member for wiping the nozzle formation surface 44a of each of the individual unit heads 11, and a capping mechanism 47 is used to cap the nozzle formation surface 44a of the unit heads 11 and the adhesion prevention plate 29. Here, the wiper plate 46 is employed as the wiping member. However, instead of the blade shape made of a rubber, a fabric may also be employed which has series of protrusions at portions which contact with the nozzle formation surface 44a. Specifically, the material or shape of the wiping member is not limited as long as the wiping member wipes the nozzle formation surface 44a.

Hereinafter, the wiper blade 46 used as the wiping member will be described. The wiper blade 46 is made of an elastic material such as a rubber or an elastomer. When the line head module 3 is moved along the guide shaft 12 in the Y direction in a wiping direction, the wiper blade 26 comes in contact and slides across the nozzle formation surface 44a of the corresponding unit head 11 to wipe off any residual ink A adhered to the nozzle formation surface 44a. In addition, the printer 1 of the invention may have a configuration wherein the wiper blade 46 is moved in the opposite direction to the Y direction while fixing the line head module 3. This means that a configuration may be used for allowing the wiper blade 46 to moved relative to the nozzle formation surface 44a.

Next, the wiping operation of the wiper blade 46 to performed on the nozzle formation surface 44a of the unit head 11 will be described. As shown in FIG. 4A, the head module 3 is moved relative to the wiper blade 46 in the Y direction so that the free end or front end of the wiper blade 46 is positioned to be higher than the nozzle formation surface 44a of the unit head 11. Then, as shown in FIG. 4B, the free end side of the wiper blade 46 comes in contact and slides across the nozzle formation surface 44a while it is bent toward the Y direction so as to wipe the ink A adhered to the nozzle formation surface 44a so that the ink A becomes adhered to the wiper blade 46, as shown in FIG. 4C. When the wiper blade 46 passes the edge of the nozzle formation surface 44a returns from its bent state, the ink A adhered to the wiper blade 46 is scattered toward and lands on the adhesion prevention plate 29, as shown in FIG. 4D. By way of comparison, where the adhesion prevention plate 29 is not provided, ink A′ (shown as a dashed line in FIG. 4D) that is sprayed from the wiper blade 46 becomes adhered to a unit head 11′ on the downstream side in the Y direction from the adhesion prevention plate 29.

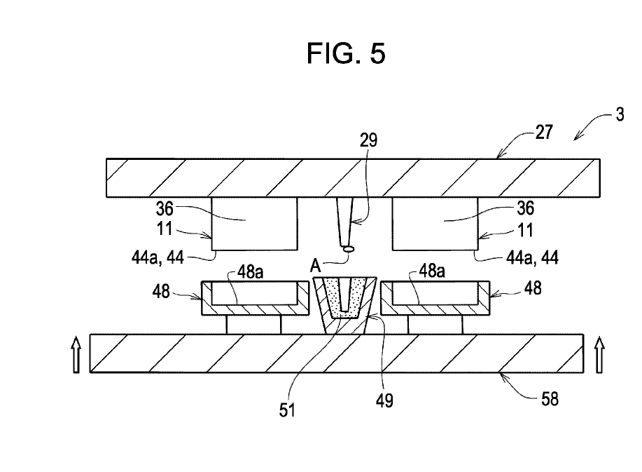

FIG. 5 is a sectional view for explaining the capping mechanism 47 related to the invention. The capping mechanism 47 includes a head cap 48, or first cap portion, for capping the nozzle formation surface 44a of each of the unit heads 11 and an adhesion prevention plate cap 49, or second cap portion, for capping the adhesion prevention plate 29.

The head cap 48 is formed in the shape of a tray made of an elastic member such as an elastomer, and a bottom surface 48a thereof is disposed above a bed plate 58 when opposed to the nozzle formation surface 44a of each of the unit heads 11. The head cap 48 allows the bed plate 58 to be raised to the nozzle formation surface 44a of the corresponding unit head 11 such that the bottom surface 48a comes in pressing contact with the nozzle formation surface 44a and seals it. Accordingly, the head cap 48 prevents ink solvent in the nozzle opening 28 from drying, thereby suppressing the thickening of the ink.

The adhesion prevention plate cap 49 has the shape of a bowl having an absorbing material 51 on its inner surface for adsorbing liquid such as ink, and is disposed at a position opposed to the adhesion prevention plate 29 of the bed plate 58. The head cap 48 allows the bed plate 58 to move towards to the adhesion prevention plate 29 such that the absorbing material 51 comes in contact with the adhesion prevention plate 29. Accordingly, the ink adhered to the adhesion prevention plate 29 is adsorbed onto the absorbing material 51 such that the ink A that landed on the adhesion prevention plate 29 can be recovered.

In addition, the adhesion prevention plate 29 of the invention may be formed from an absorbing material. Using this configuration, the ink A that lands on the adhesion prevention plate 29 is absorbed by the absorbing material. Therefore, it is possible to prevent the ink A adhered to the adhesion prevention plate 29 from falling on to the print sheets 4.

According to this embodiment, the unit head 11 and the wiper blade 46 are moved relative to each other in the Y direction so that the wiper blade 46 having elasticity comes in contact and slides across the nozzle formation surface 44a of the unit head 11 in order to wipe the nozzle formation surface 44a. In addition, the adhesion prevention plate 29 is provided to the base portion 27 on the downstream side of the unit head 11 in the Y direction. Therefore, even if the ink A, which has previously become adhered to the wiper blade 49 during the wiping of the nozzle formation surface 44a sprays or scatters as the wiper blade 46 springs back to its original shape, the path of the flying ink A is blocked by the adhesion prevention plate 29 and the ink A lands on the adhesion prevention plate 29. Therefore, it is possible to prevent the ink A from spraying in the area around the unit head 11. As a result, it is possible to suppress the defects of the unit ejection head 11 due to the adhesion of liquid droplets to the side surface of the unit head 11 or the generation of printing errors due to the adhesion of the ink A to the nozzle opening 28 of the nozzle substrate 44.

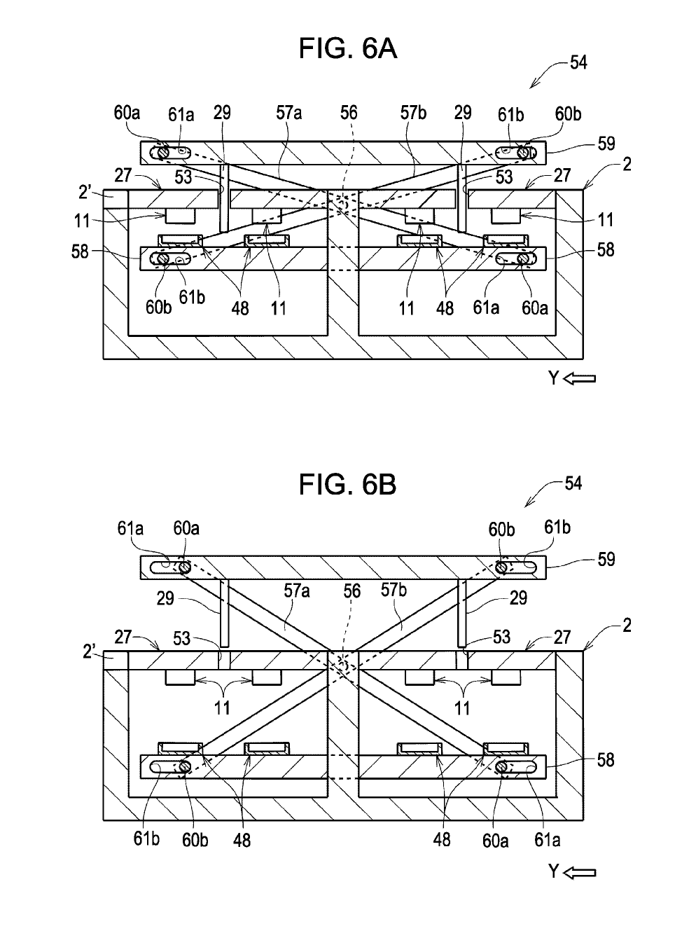

Next, another embodiment of the invention will be described. FIGS. 6A and 6B are sectional views for explaining the configuration of the line head module 3 according to a second embodiment of the invention. In the second embodiment, the base portion 27 is provided with a slit 53, and an elevating mechanism 54 is provided. The elevating mechanism 54 includes rotation plates 57a and 57b which rotate on a shaft 56 provided in the housing 2, a bed plate 58 provided with the head cap 48, and a top plate 59 provided with the adhesion prevention plate 29. The slit 53 penetrates the base portion 27 and has a width slightly larger than that of the adhesion prevention plate 29 in a Y direction such that the adhesion prevention plate 29 can be vertically inserted in and drawn out. The rotation plates 57a and 57b are provided with pins 60a and 60b at both end portions. In addition, the bed plate 58 and the top plate 59 are disposed so as to be parallel to each other while being supported by the rotation plates 57a and 57b, and both end portions thereof are provided with guide holes 61a and 61b having lengths such that the pins 60a and 60b are inserted into the guide holes 61a and 62b and slide in the Y direction.

In addition, during the wiping process, as illustrated in FIG. 6A, the elevating mechanism 54 is lowered so that the adhesion prevention plate 29 is inserted into the slit 53 so that the front end of the adhesion prevention plate 29, which is separated from the top plate 59, is positioned to be lower than the nozzle formation surface 44a of the unit head 11. Accordingly, the trajectory of the ink A as it is sprayed from the wiper blade 46 can be blocked, thereby preventing liquid droplets from landing on the adjacent unit head 11.

When the wiping process is not being performed, as illustrated in FIG. 6B, the pins 60a and 60b inserted into the guide holes 61a and 61b of the bed plate 58 slide so as to approach each other and the pins 60a and 60b inserted into the guide holes 61a and 61b of the top plate 59 slide so as to approach each other. The rotation plates 57a and 57b are rotated on the shaft 56 to separate the top plate 59 and the bed plate 58 in opposite directions. In addition, when the rotation plates 57a and 57b are rotated, the elevating mechanism 54 is lifted, and the adhesion prevention plate 29 is extracted from the slit 53 such that the adhesion prevention plate 29 is accommodated in the base portion 27. Accordingly, the adhesion prevention plate 29 is accommodated in the base portion 27 when the wiping process is not being performed. Therefore, although the ink A lands on the adhesion prevention plate 29, it is possible to reliably prevent the ink A from falling to the print sheet 4.

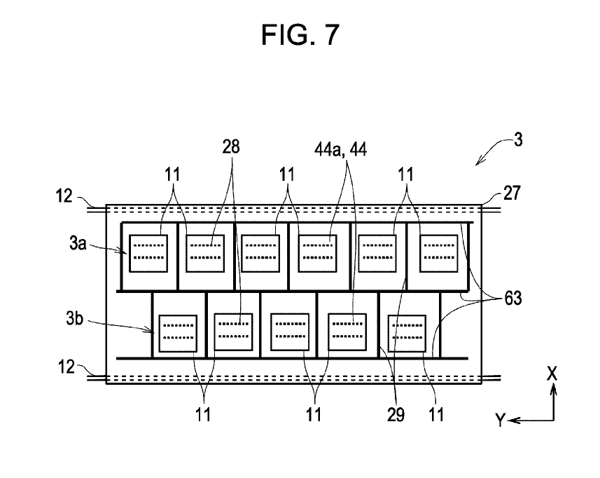

FIG. 7 is a plan view illustrating the configuration of the line head module 3 according to a third embodiment of the invention. In the third embodiment, connection plates 63 are provided for connecting the adhesion prevention plates 29 for each of the unit heads 11. Specifically, the connection plates 63 are disposed on both sides of each of the unit heads 11 in the X direction. Accordingly, the stiffness of the base portion 27 can be enhanced. In addition, since the side surfaces of the unit head 11 are surrounded by the adhesion prevention plates 29 and the connection plates 63, the area which covers the unit head 11 is increased. Therefore, it is possible to reliably prevent the ink A scattered from the wiper blade 46 from landing on the unit head 11.

Although the embodiments recited above are described with reference to a printer, the invention can also be applied to other liquid ejection heads. For example, the invention may also be used as a color material ejection head for manufacturing a color filter used in a liquid crystal display or the like, as an electrode material ejection head for forming an electrode of an organic electroluminescence (EL) display, a field emission display (FED) and the like, and as a bio-organic material ejection head used for manufacturing a biochip (biochemical element) and as a liquid ejection apparatus having liquid ejection heads so long as they have a head module comprised of plurality of liquid ejection heads.

What is claimed is:

1. A liquid ejection unit comprising:
a liquid ejection head for discharging liquid droplets through a nozzle opening on a nozzle formation surface;
a carriage that holds the liquid ejection head, the carriage including an adhesion prevention plate; and
a wiping member,
wherein the liquid ejection head and the wiping member are moved relative to each other to allow the wiping member to come in contact and slide across the nozzle formation surface of the liquid ejection head, thereby wiping the nozzle formation surface in a wiping direction, and wherein the adhesion prevention plate is provided in the carriage on the downstream side of the liquid ejection head in the wiping direction.

2. The liquid ejection head unit according to claim 1, wherein the adhesion prevention plate is formed from an absorbing material.

3. The liquid ejection head unit according to claim 1, wherein the adhesion prevention plate is accommodated in the carriage when a wiping operation is not being performed.

4. The liquid ejection head unit according to claim 3, wherein the accommodated adhesion prevention plate protrudes further from the carriage than the nozzle formation surface of the liquid ejection head when the adhesion prevention plate is in use.

5. The liquid ejection head unit according to claim 1, further comprising:
a first cap portion that caps the liquid ejection head; and
a second cap portion that caps the adhesion prevention plate.

6. A liquid ejection head module comprising:
a plurality of individual liquid ejection heads for discharging liquid droplets from a plurality of corresponding nozzle openings in nozzle formation surfaces of the individual liquid ejection heads;
a carriage that holds the individual liquid ejection heads;
a series of adhesion prevention plates formed on the carriage between the individual liquid ejection heads;
a wiping member; and
a connection plate that connects the adhesion prevention plates which are provided for the liquid ejection heads,
wherein the liquid ejection heads and a wiping member are moved relative to each other to allow the wiping member to come in contact and slide across the nozzle formation surface of the liquid ejection heads, thereby wiping the nozzle formation surface in a wiping direction, and wherein the adhesion prevention plates are positioned on downstream side of the individual liquid ejection heads in the wiping direction.

7. A liquid ejection apparatus having the liquid ejection head module according to claim 6.

8. A liquid ejection head module comprising:
a plurality of individual liquid ejection heads for discharging liquid droplets from a plurality of corresponding nozzle openings in nozzle formation surfaces of the individual liquid ejection heads;
a carriage that holds the individual liquid ejection heads;
a wiping member which is capable of moving relative to the individual liquid ejection heads to come into contact and slide across the nozzle formation surface of the liquid ejection heads so as to wipe the nozzle formation surfaces in a wiping direction;
a series of retractable adhesion prevention plates formed on the carriage between the individual liquid ejection heads in the wiping direction which are capable of being extended during a wiping process so as to prevent liquid wiped from a first individual liquid ejection head from being sprayed towards or transferred onto a second individual liquid ejection head during the wiping process;
a first cap portion that caps the liquid ejection head; and
a second cap portion that caps the adhesion prevention plate when adhesion prevention plate is not being used in a wiping process.

9. The liquid ejection head module according to claim 8, wherein the adhesion prevention plate is formed from an absorbing material.

10. The liquid ejection head module according to claim 8, wherein the adhesion prevention plate is retracted into the carriage when a wiping operation is not being performed.

11. The liquid ejection head module according to claim 3, wherein the accommodated adhesion prevention plate protrudes further from the carriage than the nozzle formation surfaces of the individual liquid ejection heads when the adhesion prevention plate is in use.
